(19) United States
(12) Patent Application Publication
(10) Pub. No.: US 2017/0139588 A1
(43) Pub. Date: May 18, 2017

(54) METHOD AND DEVICE FOR SWITCHING KEYBOARD STYLE

(71) Applicant: Xiaomi Inc., Beijing (CN)

(72) Inventors: Liangxiong WU, Beijing (CN); Liang ZHANG, Beijing (CN); Ke WANG, Beijing (CN)

(73) Assignee: Xiaomi Inc,

(21) Appl. No.: 15/149,673

(22) Filed: May 9, 2016

(30) Foreign Application Priority Data
Nov. 13, 2015 (CN) 201510781612.3

(51) Int. Cl. G06F 3/0488; G06F 3/0481; G06F 3/0346; G06F 3/0484

(52) U.S. Cl. CPC G06F 3/04886; G06F 3/04845; G06F 3/0481; G06F 3/0346

(57) ABSTRACT

A method and a device for switching a keyboard style are provided. The method includes, in a first scene interface, starting a single-hand operation mode. The method also includes judging whether a current keyboard style is a first keyboard style. The method further includes, when it is determined that the current keyboard style is the first keyboard style, switching the first keyboard style to a second keyboard style in a second interface corresponding to the single-hand operation mode, wherein an input area in the first keyboard style has a smaller size than an input area in the second keyboard style.

### CROSS-REFERENCE TO RELATED APPLICATIONS

This application is based upon and claims priority to Chinese Patent Application No. 201510781612.3, filed on Nov. 13, 2015, the entire contents of which are incorporated herein by reference.

### TECHNICAL FIELD

The present disclosure generally relates to the field of terminal technologies, and more particularly, to a method and a device for switching a keyboard style.

### BACKGROUND

As users' demand on the terminal display effect becomes higher, display screens of terminals are becoming larger. Although a large display screen improves the display effect, it brings some inconvenience to the users in single-hand operations.

To facilitate users to perform single-hand operations on large display screens, terminals can implement a single-hand operation mode. When the single-hand operation mode is started, a terminal shrinks the current display interface and displays the shrunk display interface at a lower region of the display screen, so that users can perform a single-hand operation at any location on the shrunk display interface.

For example, a terminal displays an input area and a keyboard (e.g., a QWERTY keyboard) within an input interface. If the single-hand operation mode is started, the terminal shrinks the input interface and displays a shrunk input area and a shrunk keyboard within the shrunk input interface.

### SUMMARY

According to a first aspect of the embodiments of the present disclosure, a method for switching a keyboard style is provided. The method includes, in a first scene interface, starting a single-hand operation mode. The method also includes judging whether a current keyboard style is a first keyboard style. The method further includes, when it is determined that the current keyboard style is the first keyboard style, switching the first keyboard style to a second keyboard style in a second interface corresponding to the single-hand operation mode, wherein an input area in the first keyboard style has a smaller size than an input area in the second keyboard style.

According to a second aspect of the embodiments of the present disclosure, a device for switching a keyboard style is provided. The device includes a processor and a memory configured to store instructions executable by the processor. The processor is configured to execute the instructions to start a single-hand operation mode in a first interface, judge whether a current keyboard style is a first keyboard style, and switch the first keyboard style to a second keyboard style in a second interface corresponding to the single-hand operation mode when it is determined that the current keyboard style is the first keyboard style, wherein an input area in the first keyboard style has a smaller size than an input area in the second keyboard style.

According to a third aspect of the embodiments of the present disclosure, a non-transitory computer-readable storage medium is provided. The non-transitory computer-readable storage medium has stored therein instructions that, when executed by a processor of a mobile terminal, cause the mobile terminal to perform a method for switching a keyboard style. The method includes, in a first interface, starting a single-hand operation mode. The method also includes judging whether a current keyboard style is a first keyboard style. The method further includes, when it is determined that the current keyboard style is the first keyboard style, switching the first keyboard style to a second keyboard style in a second interface corresponding to the single-hand operation mode, wherein an input area in the first keyboard style has a smaller size than an input area in the second keyboard style.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for switching a keyboard style according to an exemplary embodiment.

FIG. 2A is a flowchart showing a method for switching a keyboard style according to another exemplary embodiment.

FIG. 2B is a diagram illustrating a prompt message displayed on a screen of a device for requesting a user to confirm whether to switch a keyboard style according to an exemplary embodiment.

FIG. 3 is a block diagram illustrating a plurality of modules included in a device for switching a keyboard style according to an exemplary embodiment.

FIG. 4 is a block diagram illustrating a plurality of modules included in a device for switching a keyboard style according to another exemplary embodiment.

FIG. 5 is a block diagram illustrating a device including a function for switching a keyboard style according to an exemplary embodiment.

### DETAILED DESCRIPTION

To better illustrate the purpose, the technical scheme, and the advantages of the present disclosure, embodiments of the present disclosure are described below in further details in conjunction with the accompanying drawings.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the embodiments of the present disclosure. Instead, they are merely examples of apparatuses and methods consistent with aspects related to the embodiments of the present disclosure as recited in the appended claims.

Before describing the embodiments in detail, the single-hand operation mode is first explained as follows.

When the display screen of a terminal is too large, a user cannot reach and touch many positions on the display screen during the single-hand operation, which makes the single-hand operation difficult. Consistent with the disclosed embodiments, if the terminal starts the single-hand operation mode when an interface is currently displayed, the terminal shrinks the current interface and displays the shrunk interface at a lower region of the display screen. The shrunk interface allows the fingers of the user to reach and touch any location on the shrunk interface, thereby enabling the user to perform single-hand operations in the shrunk interface.

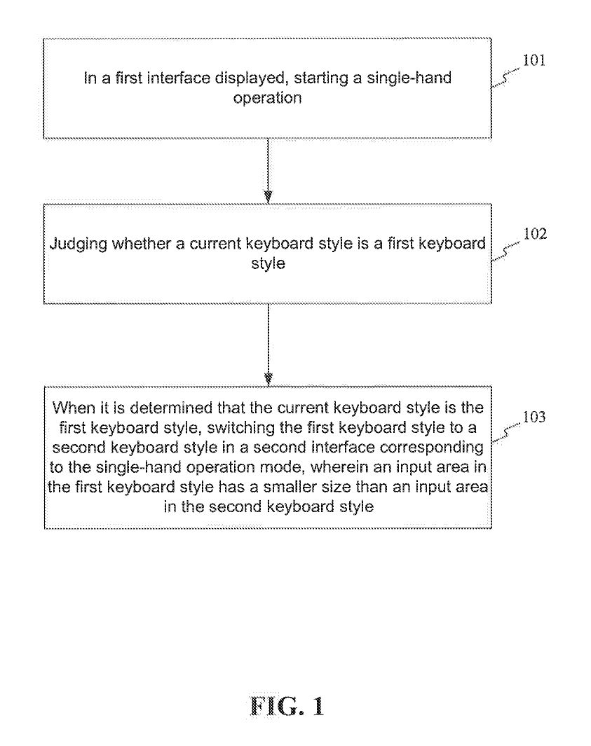

FIG. 1 is a flowchart showing a method for switching a keyboard style according to an exemplary embodiment. As shown in FIG. 1, the method for switching a keyboard style, which is performed by a terminal, includes the following steps:

In Step 101: in a first interface displayed on a display screen of the terminal, the terminal starts a single-hand operation mode.

In Step 102: the terminal judges whether the current keyboard style is a first keyboard style.

In Step 103: when the terminal determines that the current keyboard style is the first keyboard style, the terminal switches the first keyboard style to a second keyboard style in a second interface displayed corresponding to the single-hand operation mode. An input area in the first keyboard style has a smaller size than an input area in the second keyboard style.

In related art, if the single-hand operation mode is started when a user inputs through a keyboard, the current interface is shrunk, and the keyboard displayed on the current interface is shrunk accordingly. Keyboards may include several styles, each of which may have an input area of a different size. If the current keyboard style is associated with an input area having a smaller size, shrinking the current keyboard may make the input area too small, making it easier for the users to introduce errors in input operations. This affects a user's normal input and reduces the input efficiency.

In the disclosed embodiments, when the single-hand operation mode is started, if the current keyboard style is the first keyboard style associated with an input area having a relatively smaller size, the terminal automatically switches the first keyboard style to a second keyboard style associated with an input area having a relatively larger size. In this way, even when the keyboard is shrunk, the size of the input area is not too small. Therefore, input operation errors can be reduced or avoided, impact on a user's normal input operations can be avoided, and the input efficiency in the single-hand operation mode can be improved.

By switching the current first keyboard style associated with an input area having a relatively smaller size to a second keyboard style associated with an input area having a relatively larger size when starting the single-hand operation mode, the disclosed methods reduce or avoid a user's input operation errors, thereby reducing or avoiding the impact on the user's normal input operations and improving the input efficiency in the single-hand operation mode.

In some embodiments, the method further includes:

when exiting from the single-hand operation mode, switching the second keyboard style to the first keyboard style in the first interface.

In some embodiments, the method further includes:

judging whether a keyboard includes the first keyboard style and the second keyboard style;

when it is determined that the keyboard includes the first keyboard style and the second keyboard style, displaying a prompt message, wherein the prompt message requests a user to confirm whether to switch the keyboard style in the single-hand operation mode; and

when detecting a confirm operation in response to the prompt message, determining to switch the keyboard style in the single-hand operation mode.

In some embodiments, when it is determined that the current keyboard style is the first keyboard style, then in a second interface displayed corresponding to the single-hand operation mode, the terminal switches the first keyboard style to a second keyboard style. For example, when it is determined to switch the keyboard style in the single-hand operation mode and when it is determined that the current keyboard style is the first keyboard style, the terminal switches the first keyboard style to the second keyboard style in the second interface.

In some embodiments, when it is determined that the current keyboard style is the first keyboard style, then in a second interface displayed corresponding to the single-hand operation mode, the terminal switches the first keyboard style to the second keyboard style. For example, when it is determined that the current keyboard style is the first keyboard style and the current display screen is in a vertical screen state, the terminal switches the first keyboard style to the second keyboard style in the second interface displayed corresponding to the single-hand operation mode.

In some embodiments, the first keyboard style is a QWERTY style and the second keyboard style is a nine-square grid style.

All of the above optional technical schemes can be implemented in any combinations as optional embodiments of the present disclosure. Detailed description of the various combinations is omitted.

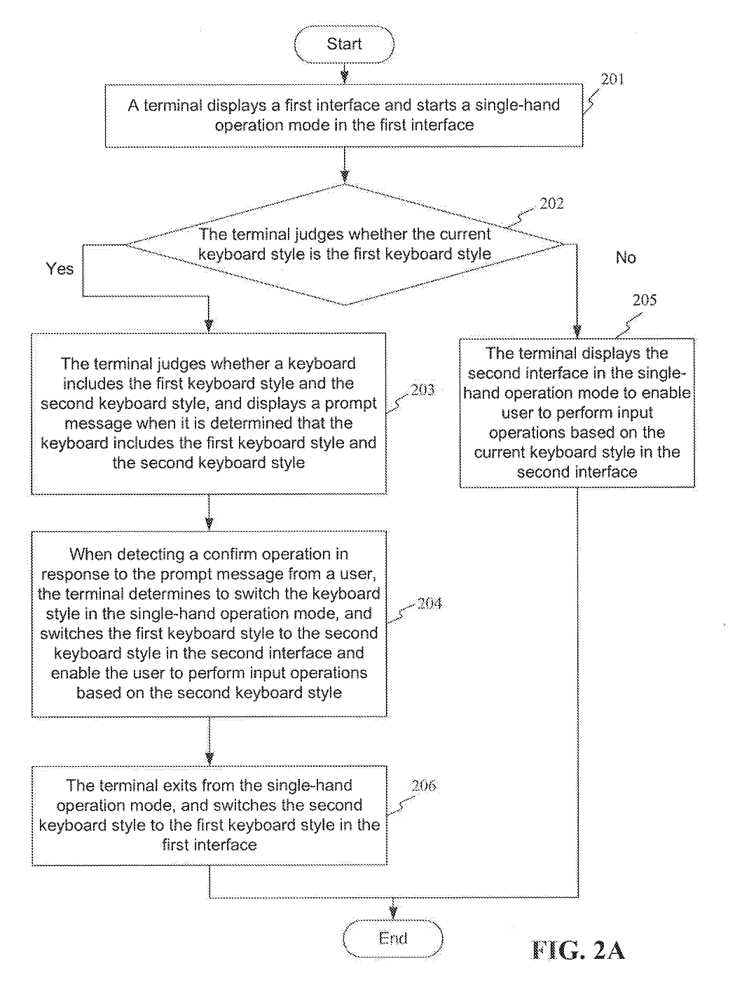

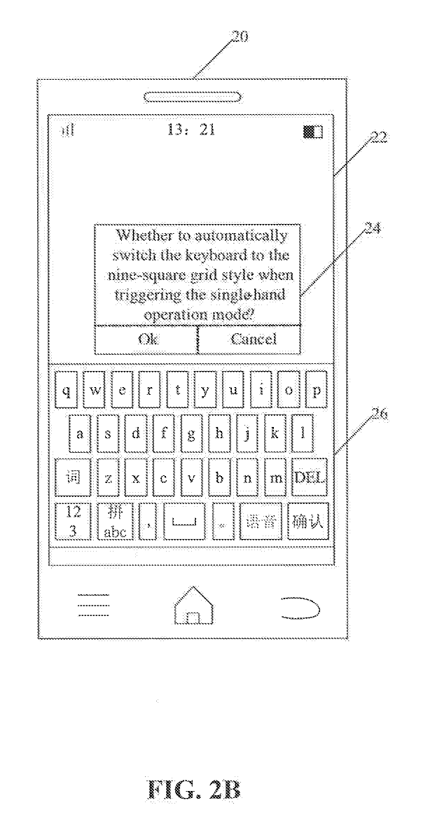

FIG. 2A is a flowchart showing a method for switching a keyboard style according to another exemplary embodiment. As shown in FIG. 2A, the method for switching a keyboard style, which is performed by a terminal, includes the following steps:

In Step 201: the terminal displays a first interface and starts a single-hand operation mode in the first interface.

The terminal may be a mobile phone, a tablet computer, a computer, and so on. The terminal may be any suitable equipment or device provided with a large display screen. The disclosed embodiments do not limit the type of terminal.

In some embodiments, a mode in which the terminal is not in the single-hand operation mode is referred to as a normal operation mode. The first interface, displayed by the terminal in the normal operation mode, has the same size as or a smaller size than the display screen of the terminal. The disclosed embodiments do not limit the size of the first interface.

For example, the first interface may be an interface displayed for a call, a message, a game, a video playback, a browser search, and other interfaces displayed in the normal operation mode. The disclosed embodiments do not limited the type of the first interface.

In the first interface, when the display screen of the terminal is too large, a user cannot reach and touch many positions on the display screen in the single-hand operation mode, making the single-hand operation difficult. To facilitate the single-hand operation, the terminal starts the single-hand operation mode in the first interface. For example, the single-hand operation may be automatically started by the terminal according to the data amount displayed in the first interface. Alternatively or additionally, the single-hand operation may be started by a user's triggering operation, such as double-clicking the Home button of the terminal or long-pressing the display screen. The disclosed embodiments do not limit the manner in which the single-hand operation mode is started.

After the single-hand operation mode is started in the first interface displayed on the terminal, the terminal may shrink the current first interface and display the shrunk first interface at a lower region of the display screen, which is referred to as a second interface. The fingers of a user can reach and touch any position on the shrunk interface to carry out single-hand operations in the shrunk first interface (i.e., the second interface).

After starting the single-hand operation mode while displaying the first interface, the terminal displays the second interface which has a smaller size than the first interface. The terminal can display the second interface in a first preset region of the display screen. Subsequently, when the terminal receives a position switching instruction associated with the second interface, the terminal can display the second interface in a second preset region of the display screen.

The first preset region and the second preset region are located at different locations on the display screen. For example, the first preset region and the second preset region may be located at the central lower region, the left lower region, the right lower region, or other locations of the display screen that are convenient for users' single-hand operations. The first preset region and the second preset region may be set by the terminal in advance or may be manually set by a user. The disclosed embodiments do not limit the manner in which the first preset region and the second preset region are set. In addition, the terminal may display a position switching option in the second interface. Position switching instructions can be triggered by a user clicking or pressing the position switching option or by other operations, which are not limited in the disclosed embodiments.

For example, when a user starts the single-hand operation mode by clicking the right lower region of the display screen in the first interface, the terminal displays the second interface at the right lower region of the display screen. The user can carry out single-hand operations conveniently with the right hand. When the user feels tired after having operated with the right hand for a long time, the user can click the left lower region of the display screen to trigger a position switching instruction. After receiving the position switching instruction, the terminal displays the second interface at the left lower region of the display screen, such that the user can carry out single-hand operations conveniently with the left hand.

In Step 202: the terminal judges whether the current keyboard style is the first keyboard style. If the current keyboard style is the first keyboard style (Yes, Step 202), the terminal executes Step 203. Otherwise, if the current keyboard style is not the first keyboard style (No, Step 202), the terminal executes Step 205.

Considering that the size of the second interface displayed by the terminal is relatively small after the single-hand operation mode is started, if the user is to input through the keyboard provided in the second interface, the size of the keyboard displayed by the terminal for receiving the user input is also relatively small. The keyboard may include several keyboard styles, each of which may have an input area of a different size. If the current keyboard style is one in which the input area has a smaller size, the input area may become too small when the keyboard is displayed according to the current keyboard style in the second interface. Consequently, errors may be easily introduced in user's input operations. This affects the user's normal input and reduces the input efficiency. The input area of the keyboard may include keys provided on the keyboard. Additionally or alternatively, the input area may include an area for detecting the sliding operations of users. The disclosed embodiments do not limit the input area.

To solve the problem associated with the input area of the keyboard being too small in the single-hand operation mode, the terminal may judge, in advance, whether the current keyboard style is the first keyboard style when starting the single-hand operation mode. The first keyboard style is the one in which the input area has a relatively smaller size. For example, the first keyboard style may be a QWERTY style. In addition, the first keyboard style can be determined by the terminal according to the size of the input area of each keyboard style, or can be set by a user. The first keyboard style may include one or more keyboard styles. The disclosed embodiments do not limit the keyboard styles.

If the current keyboard style is the first keyboard style, after the single-hand operation mode is started, the size of the input area of the keyboard in the second interface may be too small, which impacts the normal input of the user in the single-hand operation mode. To facilitate the normal input of the user in the single-hand operation mode, it is desirable to switch the keyboard style when starting the single-hand operation mode and to execute Step 203, in order to avoid causing errors in the user's input process.

If the current keyboard style is not the first keyboard style, after the single-hand operation mode is started, the size of the input area of the keyboard in the second interface may be sufficiently large, and does not impact the normal input of the user in the single-hand operation mode. In such situations, the terminal does not need to switch the keyboard style when starting the single-hand operation mode. The terminal can directly execute Step 205 to display the second interface, through which the user can perform input operations directly on the current keyboard style.

In Step 203: the terminal judges whether the keyboard includes the first keyboard style and the second keyboard style, and displays a prompt message when it is determined that the keyboard includes the first keyboard style and the second keyboard style.

The second keyboard style is the one having an input area that has a relatively larger size. For example, the second keyboard style may be a nine-square grid style or a handwritten keyboard style. The second keyboard style can be determined by the terminal according to the size of the input area of each keyboard style, or can be set by a user. The second keyboard style can include one or more keyboard styles. The disclosed embodiments do not limit the second keyboard style.

In some embodiments, an input area in the first keyboard style has a smaller size than an input area in the second keyboard style. For example, the first keyboard style is a QWERTY style, and the second keyboard style is a nine-square grid style. As another example, the first keyboard style is a nine-square grid style and the second keyboard style is a handwritten style.

To improve efficiency, after the terminal determines that the current keyboard style is the first keyboard style, the terminal may further judge whether the keyboard includes the first keyboard style and the second keyboard style. If the keyboard does not include the first keyboard style or the second keyboard style, which indicates that the keyboard cannot be switched between the first keyboard style and the second keyboard style, the terminal does not perform a switch. Rather, the terminal directly executes Step 205. If the keyboard includes the first keyboard style and the second keyboard style, which indicates that the keyboard can be switched between the first keyboard style and the second keyboard style, then the terminal can display, on the second interface, a prompt message to request a user to confirm whether to switch the keyboard style in the single-hand operation mode, such that the user may determine whether to switch the keyboard style.

Referring to FIG. 2B, which shows a prompt message displayed on a display screen of a device for requesting a user to confirm whether to switch a keyboard style. As shown in FIG. 2B, a terminal 20 displays, in a normal operation mode, an input interface 22, in which the keyboard style is a QWERTY style 26. The keyboard supports the switch between the QWERTY style and the nine-square grid style. To facilitate the normal input by a user in the single-hand operation mode, the terminal 20 displays a prompt message 24, which requests the user to confirm whether to automatically switch the keyboard to the nine-square grid style when triggering the single-hand operation mode.

It is to be noted that Step 203 is an optional step, which may not be executed by the terminal. When determining that the current keyboard style is the first keyboard style, the terminal may directly switch the first keyboard style to the second keyboard style. The disclosed embodiments do not limit whether Step 203 is executed.

In Step 204: when detecting that a user performs a confirm operation in response to the prompt message, the terminal determines to switch the keyboard style in the single-hand operation mode, and switches the first keyboard style to the second keyboard style in the second interface to enable the user to perform input operations based on the second keyboard style. Subsequently, the terminal executes Step 206 to exit the single-hand operation mode, as described below.

If the user agrees to switch the keyboard style in the single-hand operation mode, the user can trigger a confirm operation in response to the prompt message. When detecting the confirm operation in response to the prompt message from the user, the terminal switches the first keyboard style to the second keyboard style in the second interface.

Referring to FIG. 2B, after the user clicks the OK button in the prompt message 24, the terminal detects the confirm operation input by the user in response to the prompt message, and determines that the user agrees to automatically switch the keyboard to the nine-square grid style when triggering the single-hand operation mode. After starting the single-hand operation mode, the terminal automatically switches the QWERTY style 26 shown in FIG. 2B to the nine-square grid style in the second interface. Then, the user can perform input operations based on the nine-square grid style in the second interface.

In the disclosed embodiments, if the single-hand operation mode is started when the first interface displays the keyboard of the first keyboard style, the terminal automatically switches the keyboard style and displays the keyboard of the second keyboard style in the second interface. If the single-hand operation mode is started when the first interface does not display a keyboard, the terminal automatically switches the keyboard style and displays the second interface that is generated by shrinking the first interface. Subsequently, if it is detected in the second interface a user operation invoking a keyboard, the terminal displays the keyboard of the second keyboard style in the second interface. Then the user can perform input operations based on the second keyboard style in the second interface.

In addition, if the current keyboard style is the first keyboard style, considering that the display area is sufficiently large in the landscape mode, even if the single-hand operation mode is started in the landscape mode, the size of the input area in the first keyboard style is sufficiently large in the second interface, and does not impact the normal input of the user. Therefore, in some embodiments, the keyboard style used in the single-hand operation mode may not be switched in the landscape mode, while the keyboard style used in the single-hand operation mode may be switched in the vertical (or portrait) screen state. In other words, when it is determined the current keyboard style is the first keyboard style and the current display screen is in a vertical screen state, the first keyboard style is switched to the second keyboard style in the second interface.

For example, when it is determined that the keyboard style is the first keyboard style, the terminal may further judge whether the current display screen is in a vertical screen state. If the current display screen is in the vertical screen state, the first keyboard style is switched to the second keyboard style in the second interface, and the user can perform input operations based on the second keyboard style. If the current display screen is in a landscape state, the keyboard style is not switched and the user can perform input operations based on the first keyboard style.

In the above embodiments, Step 203 and Step 204 are described as being executed while the single-hand operation mode is started. In some embodiments, Step 203 and Step 204 may be executed at any time in the normal operation mode. For example, Step 203 and Step 204 may be executed when the terminal detects, in the normal operation mode, a user operation invoking a keyboard, or when the terminal is restarted. The disclosed embodiments do not limit the time when Step 203 and Step 204 are executed.

In Step 205: the terminal displays the second interface in the single-hand operation mode to enable the user to perform input operations based on the current keyboard style in the second interface.

When the single-hand operation mode is started, the terminal does not switch the current keyboard style, but instead, directly displays the second interface. Subsequently, when the terminal detects a user operation invoking a keyboard, the terminal displays the current keyboard style in the second interface, that is, the keyboard style used before the single-hand operation mode is started. The user can perform input operations based on the current keyboard style.

In Step 206: the terminal exits from the single-hand operation mode, and switches the second keyboard style to the first keyboard style in the first interface.

Specifically, the terminal can exit from the single-hand operation mode automatically according to the data amount displayed in the first interface or according to an operation triggered by a user in the single-hand operation mode, such as double-clicking the Home button or long-pressing the display screen. The disclosed embodiments do not limit the exit manner.

When the terminal exits from the single-hand operation mode, the terminal restores or switches the second keyboard style to the first keyboard style used before the single-hand operation mode is started. Subsequently, when a user operation invoking a keyboard is detected, the terminal displays the keyboard according to the first keyboard style in the first interface. The user can perform input operations based on the first keyboard style.

For example, if the keyboard style used before the single-hand operation mode is started is a QWERTY style, and the keyboard style used in the single-hand operation mode is a nine-square grid style, then after exiting from the single-hand operation mode, the terminal restores the keyboard style to the QWERTY style. Then the user can perform input operations through the keyboard displayed in the QWERTY style.

In some embodiments, when starting the single-hand operation mode, and before switching keyboard styles, the terminal may record or store the first keyboard style used before switching the keyboard style, and then switch the first keyboard style to the second keyboard style. Subsequently, when exiting from the single-hand operation mode, the terminal may switch the second keyboard style back to the recorded or stored first keyboard style.

The disclosed embodiments can be implemented as input applications. Through adapting interfaces between the input applications and a current application being executed by the terminal, the input applications can cause a keyboard to be displayed in an interface of the current application. Keyboard switching described above may be performed within the interface of the current application.

In related art, after starting the single-hand operation mode, the terminal only shrinks the interface, but does not optimize the display of the interface in the single-hand operation mode, or consider the difficulty associated with input operations performed through the shrunk interface. Therefore, the related art leads to a poor user experience and is not capable of meeting users' experience requirements. In the disclosed embodiments, after the single-hand operation mode is started, the terminal optimizes the switch of a keyboard style in the single-hand operation mode, thereby providing a better input experience for users.

According to the disclosed methods and devices, when starting the single-hand operation mode, by switching the current first keyboard style in which the size of the input area is relatively smaller to the second keyboard style in which the size of the input area is relatively larger, errors can be avoided in a user's input process, the impact to user's normal input can be reduced or avoided, and the input efficiency and user experience in the single-hand operation mode can be improved.

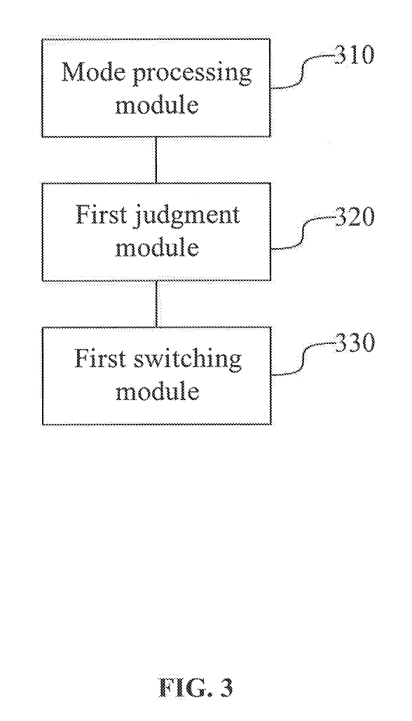

FIG. 3 is a block diagram illustrating a plurality of modules included in a device for switching a keyboard style according to an exemplary embodiment. The device (or terminal) may be a mobile phone, a tablet computer, a computer and other devices. Referring to FIG. 3, the device having a function of switching a keyboard style may include a mode processing module 310, a first judgment module 320, and a first switching module 330.

The mode processing module 310 is configured to start a single-hand operation mode in a first interface displayed on the display screen of the device.

The first judgment module 320 is configured to judge whether a current keyboard style is a first keyboard style.

The first switching module 330 is configured to switch the first keyboard style to a second keyboard style in a second interface displayed corresponding to the single-hand operation mode, when it is determined that the current keyboard style is the first keyboard style. An input area in the first keyboard style has a smaller size than an input area in the second keyboard style.

In the disclosed device, when starting the single-hand operation, mode, by switching the current first keyboard style in which the size of the input area is relatively smaller to the second keyboard style in which the size of the input area is relatively larger, errors can be avoided in a user's input process, the impact to user's normal input can be reduced or avoided, and the input efficiency and user experience in the single-hand operation mode can be improved.

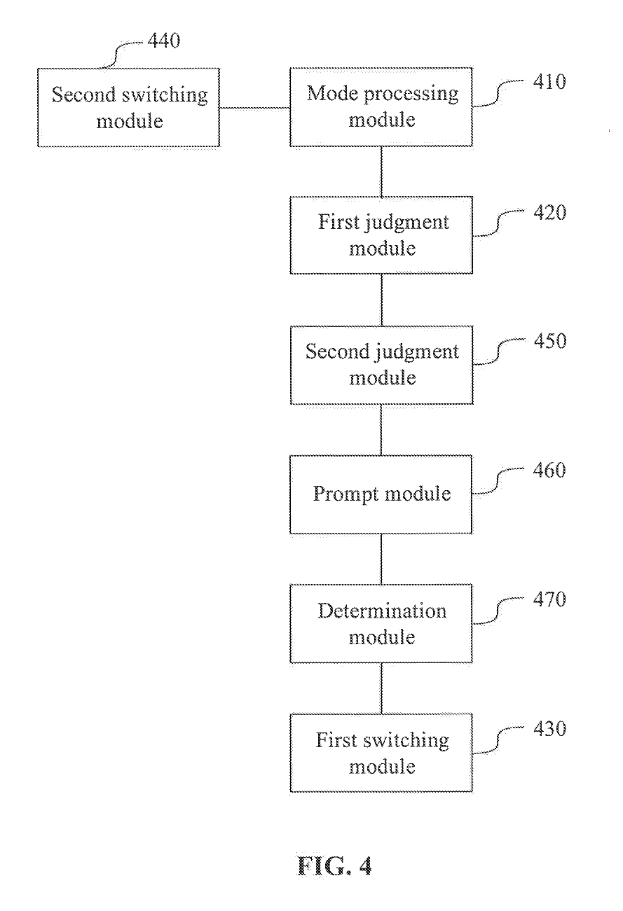

FIG. 4 is a block diagram illustrating a plurality of modules included in a device for switching a keyboard style according to an exemplary embodiment. The device (or terminal) may be a mobile phone, a tablet computer, a computer and other devices. Referring to FIG. 4, the device having a function of switching a keyboard style may include a mode processing module 410, a first judgment module 420, and a first switching module 430.

The mode processing module 410 is configured to start a single-hand operation mode in a first interface displayed on the display screen of the device.

The first judgment module 420 is configured to judge whether the current keyboard style is a first keyboard style.

The first switching module 430 is configured to switch the first keyboard style to a second keyboard style in a second interface displayed corresponding to the single-hand operation mode, when it is determined that the current keyboard style is the first keyboard style. An input area in the first keyboard style has a smaller size than an input area in the second keyboard style.

In some embodiments, the device may further include:

a second switching module 440 configured to switch the second keyboard style to the first keyboard style in the first interface when exiting from the single-hand operation mode.

In some embodiments, the device may further include:

a second judgment module 450 configured to judge whether a keyboard includes the first keyboard style and the second keyboard style;

a prompt module 460 configured to display a prompt message when it is determined that the keyboard includes the first keyboard style and the second keyboard style, wherein the prompt message requests a user to confirm whether to switch the keyboard style in the single-hand operation mode; and

a determination module 470 configured to determine to switch the keyboard style in the single-hand operation mode when detecting a confirm operation in response to the prompt message.

In some embodiments, the first switching module 430 is further configured to switch the first keyboard style to the second keyboard style in the second interface, when it is determined to switch the keyboard style in the single-hand operation mode, and when it is determined that the current keyboard style is the first keyboard style.

In some embodiments, the first switching module 430 is further configured to switch the first keyboard style to the second keyboard style in the second interface displayed corresponding to the single-hand operation mode, when it is determined that the current keyboard style is the first keyboard style and the current display screen is in a vertical screen state.

In some embodiments, the first keyboard style is a QWERTY style and the second keyboard style is a nine-square grid style.

For the device of the disclosed embodiments, the specific operations each module performs have been described in detail in the above discussion of embodiments of the disclosed methods. Therefore, further descriptions of how the modules perform various operations are omitted.

In the device of the disclosed embodiments, when starting the single-hand operation mode, by switching the current first keyboard style in which the size of the input area is relatively smaller to the second keyboard style in which the size of the input area is relatively larger, errors can be avoided in a user's input process, the impact to user's normal input can be reduced or avoided, and the input efficiency and the user experience in the single-hand operation mode can be improved.

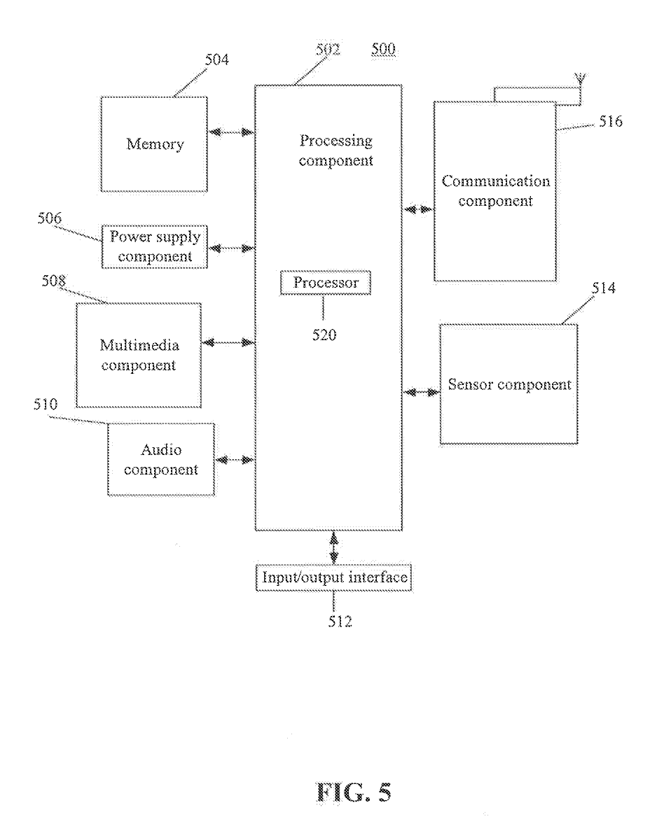

FIG. 5 is a block diagram illustrating a device 500 including a function for switching a keyboard style according to an exemplary embodiment. The device 500 may be a mobile phone, a tablet computer, a computer and other devices.

Referring to FIG. 5, the device 500 may include one or more of the following components: a processing component 502, a memory 504, a power supply component 506, a multimedia component 508, an audio component 510, a sensor component 514, an input/output interface 512, and a communication component 516.

The processing component 502 is configured to control overall operation of the device 500, such as the operations associated with display, telephone calls, data communications, camera operations and recoding operations. The processing component 502 includes one or more processors 520 configured to execute instructions to perform all or portions of the disclosed methods. Moreover, the processing component 502 may include one or more modules that facilitate the interaction between the processing module 502 and other components. For instance, the processing component 502 may include a multimedia module configured to facilitate the interaction between the multimedia component 508 and the processing component 502.

The memory 504 is configured to store various types of data to support the operation of the device 500. Examples of such data include instructions for any applications or methods executed by the device 500. The memory 504 may be implemented using any type of volatile or non-volatile memory devices, or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk. The memory 504 also stores one or more modules that are configured to be executed by one or more processors 520 to perform all or portions of the methods shown in any one of FIG. 1, FIG. 2A, and FIG. 3.

The power supply component 506 is configured to supply power to one or more components of the device 500. The power supply component 506 may include a power management system, one or more power sources, and any other components associated with the generation, management, and distribution of electrical power in the device 500.

The multimedia component 508 includes a screen that functions as an output interface between the device 500 and the user. In some embodiments, the screen may include a Liquid Crystal Display (LCD) and a Touch Panel (TP). If the screen includes the touch panel, the screen may be implemented as a touch screen configured to receive input signals from the user. The touch panel includes one or more touch sensors configured to sense touches, swipes, and gestures on the touch panel. The touch sensors may not only sense a boundary of a touch or swipe input, but also sense a period of time and a pressure associated with the touch or swipe input.

The audio component 510 is configured to output audio signals and/or receive input audio signals. For example, the audio component 510 includes a microphone configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker configured to output audio signals.

The sensor component 514 includes one or more sensors configured to provide status assessments of various aspects of the device 500. For instance, the sensor component 514 may detect an open/closed status of the device 500, relative positioning of components, a change in position of the device 500 or a component of the device 500, and a change in temperature of the device 500. The sensor component 514 may include a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, or 3G, or a combination thereof. In one exemplary embodiment, the communication component 516 receives a broadcast signal or broadcast associated information from an external broadcast management system via a broadcast channel. In some exemplary embodiments, the communication component 516 further includes a Near Field Communication (NFC) module configured to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

In exemplary embodiments, the device 500 may be implemented with one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors, or other electronic components, for performing the above described methods for switching a keyboard style.

The disclosed embodiments also provide a non-transitory computer-readable storage medium for storing instructions, such as the memory 504 that stores instructions. The instructions can be executed by the processor 520 included in the device 500 for performing the above-described methods for switching a keyboard style. For example, the non-transitory computer-readable storage medium may be a ROM, a Random-Access Memory (RAM), a Compact Disc Read-Only Memory (CD-ROM), a magnetic tape, a floppy disc, an optical data storage device, and the like.

Other embodiments of the present disclosure will be apparent to those skilled in the art from consideration of the specification and practice of the present disclosure provided here. This application is intended to cover any variations, uses, or adaptations of the embodiments of the present disclosure. Such variations, uses, or adaptations may follow the general principles of the present disclosure, and may include departures from the embodiments of the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure are not limited to the exact construction that has been described above and illustrated in the accompanying drawings, and that various modifications and changes can be made without departing from the scope thereof. It is intended that the scope of the embodiments of the present disclosure only be limited by the appended claims.

What is claimed is:

1. A method for switching a keyboard style, comprising:
in a first interface, starting a single-hand operation mode;
judging whether a current keyboard style is a first keyboard style; and
when it is determined that the current keyboard style is the first keyboard style, switching the first keyboard style to a second keyboard style in a second interface corresponding to the single-hand operation mode, wherein an input area in the first keyboard style has a smaller size than an input area in the second keyboard style.

2. The method according to claim 1, further comprising:
when exiting from the single-hand operation mode, switching the second keyboard style to the first keyboard style in the first interface.

3. The method according to claim 1, further comprising:
judging whether a keyboard includes the first keyboard style and the second keyboard style;
when it is determined that the keyboard includes the first keyboard style and the second keyboard style, displaying a prompt message, wherein the prompt message requests a user to confirm whether to switch a keyboard style in the single-hand operation mode; and
when detecting a confirm operation in response to the prompt message, determining to switch the keyboard style in the single-hand operation mode.

4. The method according to claim 3, wherein the switching the first keyboard style to the second keyboard style in the second interface corresponding to the single-hand operation mode when it is determined that the current keyboard style is the first keyboard style comprises:
when it is determined to switch the keyboard style in the single-hand operation mode and it is determined that the current keyboard style is the first keyboard style, switching the first keyboard style to the second keyboard style in the second interface.

5. The method according to claim 1, wherein the switching the first keyboard style to the second keyboard style in the second interface corresponding to the single-hand operation mode when it is determined that the current keyboard style is the first keyboard style comprises:
when it is determined that the current keyboard style is the first keyboard style and the current display screen is in a vertical screen state, switching the first keyboard style to the second keyboard style in the second interface corresponding to the single-hand operation mode.

6. The method according to claim 1, wherein the first keyboard style is a QWERTY style and the second keyboard style is a nine-square grid style.

7. The method according to claim 2, wherein the first keyboard style is a QWERTY style and the second keyboard style is a nine-square grid style.

8. The method according to claim 3, wherein the first keyboard style is a QWERTY style and the second keyboard style is a nine-square grid style.

9. The method according to claim 4, wherein the first keyboard style is a QWERTY style and the second keyboard style is a nine-square grid style.

10. The method according to claim 5, wherein the first keyboard style is a QWERTY style and the second keyboard style is a nine-square grid style.

11. A device for switching a keyboard style, comprising:
a processor;
a memory configured to store instructions executable by the processor,
wherein the processor is configured to execute the instructions to:
start a single-hand operation mode in a first interface;
judge whether a current keyboard style is a first keyboard style; and
switch the first keyboard style to a second keyboard style in a second interface corresponding to the single-hand operation mode when it is determined that the current keyboard style is the first keyboard style, wherein an input area in the first keyboard style has a smaller size than an input area in the second keyboard style.

12. The device according to claim 11, wherein the processor is further configured to:
switch the second keyboard style to the first keyboard style in the first interface when exiting from the single-hand operation mode.

13. The device according to claim 11, wherein the processor is further configured to:
judge whether a keyboard includes the first keyboard style and the second keyboard style;
display a prompt message when it is determined that the keyboard includes the first keyboard style and the second keyboard style, wherein the prompt message requests a user to confirm whether to switch a keyboard style in the single-hand operation mode; and
determine to switch the keyboard style in the single-hand operation mode when detecting a confirm operation in response to the prompt message.

14. The device according to claim 13, wherein the processor is further configured to switch the first keyboard style to the second keyboard style in the second interface when it is determined to switch the keyboard style in the single-hand operation mode and it is determined that the current keyboard style is the first keyboard style.

15. The device according to claim 11, wherein the processor is further configured to switch the first keyboard style to the second keyboard style in the second interface corresponding to the single-hand operation mode when it is determined that the current keyboard style is the first keyboard style and the current display screen is in a vertical screen state.

16. The device according to claim 11, wherein the first keyboard style is a QWERTY style and the second keyboard style is a nine-square grid style.

17. The device according to claim 12, wherein the first keyboard style is a QWERTY style and the second keyboard style is a nine-square grid style.

18. The device according to claim 13, wherein the first keyboard style is a QWERTY style and the second keyboard style is a nine-square grid style.

19. The device according to claim 14, wherein the first keyboard style is a QWERTY style and the second keyboard style is a nine-square grid style.

20. A non-transitory computer-readable storage medium having stored therein instructions that, when executed by a processor of a mobile terminal, cause the mobile terminal to perform a method for switching a keyboard style, the method comprising:
in a first interface, starting a single-hand operation mode;
judging whether a current keyboard style is a first keyboard style; and
when it is determined that the current keyboard style is the first keyboard style, switching the first keyboard style to a second keyboard style in a second interface corresponding to the single-hand operation mode, wherein an input area in the first keyboard style has a smaller size than an input area in the second keyboard style.
